(19) United States
(12) Patent Application Publication
(10) Pub. No.: US 2026/0164370 A1
(43) Pub. Date: Jun. 11, 2026

(54) FLEXIBLE POWER CLASSES FOR WIRELESS TRANSMISSIONS

(71) Applicant: QUALCOMM Incorporated, San Diego, CA (US)

(72) Inventors: Kianoush HOSSEINI, San Diego, CA (US); Timo Ville VINTOLA, San Diego, CA (US); Gokul SRIDHARAN, Sunnyvale, CA (US); Sumant Jayaraman IYER, San Diego, CA (US)

(21) Appl. No.: 19/412,516

(22) Filed: Dec. 8, 2025

Related U.S. Application Data
(60) Provisional application No. 63/730,776, filed on Dec. 11, 2024.

(51) Int. Cl. H04W 52/36; H04W 52/26

(52) U.S. Cl. CPC H04W 52/367; H04W 52/262

(57) ABSTRACT

Various aspects of the present disclosure generally relate to wireless communication. A user equipment (UE) may define un upper bound of a permissible output power for uplink transmissions in accordance with a flexible power class value. The UE may select the flexible power class value from a range of power class values configured in accordance with a capability of the UE. Additionally, the upper bound may further comply with a permissible power level associated with cell of the network node and/or one or more regulatory and/or exposure metrics. The UE may be associated with multiple maximum power reduction (MPR) tables, and may select an MPR table in accordance with selecting the flexible power class value. The UE may be associated with a power offset value and/or a duty cycle offset value that the UE may apply to the flexible power class value.

### CROSS-REFERENCE TO RELATED APPLICATION

This patent application claims priority to U.S. Provisional Patent Application No. 63/730,776, filed on Dec. 11, 2024, entitled “FLEXIBLE POWER CLASSES FOR WIRELESS TRANSMISSIONS,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods associated with flexible power classes for wireless transmissions.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

In some examples, a user equipment (UE) may transmit, and a network node may receive, one or more wireless messages. For instance, the UE may transmit a wireless message at an output power level enabled by one or more hardware components of the UE (such as one or more power amplifiers, one or more RF filters, or one or more antenna elements, among other examples). Such hardware components may determine a permissible output power capability of the UE across one or more frequencies. The UE may transmit wireless messages at an output power level that satisfies the maximum output power capability in accordance with one or more other factors associated with communicating with the network node. For example, the network node may transmit, and the UE may receive, an output power configuration that indicates one or more parameters that the UE may use to determine an output power level for wireless transmissions. Additionally, the UE may adjust the output power level in accordance with one or more regulatory and/or exposure metrics associated with a wireless communication environment that the UE resides within.

### SUMMARY

Some aspects described herein relate to a user equipment (UE) for wireless communication. The UE may include a processing system that includes one or more processors and one or more memories coupled with the one or more processors. The processing system may be configured to cause the UE to receive, from a network node, configuration information that indicates a plurality of parameters associated with an upper bound for selection of a permissible power parameter, wherein the permissible power parameter is associated with an output power for wireless transmissions to the network node. The processing system may be configured to cause the UE to transmit, to the network node, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE.

Some aspects described herein relate to a network node for wireless communication. The network node may include a processing system that includes one or more processors and one or more memories coupled with the one or more processors. The processing system may be configured to cause the network node to transmit, to a UE, configuration information that indicates a plurality of parameters associated with an upper bound for selection of a permissible power parameter, wherein the permissible power parameter is associated with an output power for wireless transmissions to the network node. The processing system may be configured to cause the network node to receive, from the UE, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE.

Some aspects described herein relate to a method of wireless communication performed by a UE. The method may include receiving, from a network node, configuration information that indicates a plurality of parameters associated with an upper bound for selection of a permissible power parameter, wherein the permissible power parameter is associated with an output power for wireless transmissions to the network node. The method may include transmitting, to the network node, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE.

Some aspects described herein relate to a method of wireless communication performed by a network node. The method may include transmitting, to a UE, configuration information that indicates a plurality of parameters associated with an upper bound for selection of a permissible power parameter, wherein the permissible power parameter is associated with an output power for wireless transmissions to the network node. The method may include receiving, from the UE, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE.

Some aspects described herein relate to a non-transitory computer-readable medium that stores a set of instructions for wireless communication by a UE. The set of instructions, when executed by one or more processors of the UE, may cause the UE to receive, from a network node, configuration information that indicates a plurality of parameters associated with an upper bound for selection of a permissible power parameter, wherein the permissible power parameter is associated with an output power for wireless transmissions to the network node. The set of instructions, when executed by one or more processors of the UE, may cause the UE to transmit, to the network node, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE.

Some aspects described herein relate to a non-transitory computer-readable medium that stores a set of instructions for wireless communication by a network node. The set of instructions, when executed by one or more processors of the network node, may cause the network node to transmit, to a UE, configuration information that indicates a plurality of parameters associated with an upper bound for selection of a permissible power parameter, wherein the permissible power parameter is associated with an output power for wireless transmissions to the network node. The set of instructions, when executed by one or more processors of the network node, may cause the network node to receive, from the UE, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE.

Some aspects described herein relate to an apparatus for wireless communication. The apparatus may include means for receiving, from a network node, configuration information that indicates a plurality of parameters associated with an upper bound for selection of a permissible power parameter, wherein the permissible power parameter is associated with an output power for wireless transmissions to the network node. The apparatus may include means for transmitting, to the network node, a message at an output power level, wherein the output power level is in accordance with the permissible power parameter selected in accordance with the upper bound and in accordance with a flexible power class value selected from a range of power class values, wherein the range of power class values indicates a range for a permissible output power capability of a UE.

Some aspects described herein relate to an apparatus for wireless communication. The apparatus may include means for transmitting, to a UE, configuration information that indicates a plurality of parameters associated with an upper bound for selection of a permissible power parameter, wherein the permissible power parameter is associated with an output power for wireless transmissions to the network node. The apparatus may include means for receiving, from the UE, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example disaggregated network node architecture in accordance with the present disclosure.

FIG. 3 is a diagram illustrating an example of a wireless device setting a permissible output power in accordance with the present disclosure.

FIG. 4 is a diagram illustrating an example associated with a flexible power class value selection for wireless transmissions in accordance with the present disclosure.

FIG. 5 is a flowchart illustrating an example process performed, for example, at a user equipment (UE) or an apparatus of a UE that supports wireless communications in accordance with the present disclosure.

FIG. 6 is a flowchart illustrating an example process performed, for example, at a network node or an apparatus of a network node that supports wireless communications in accordance with the present disclosure.

FIG. 7 is a diagram of an example apparatus for wireless communication that supports flexible power classes for wireless transmissions in accordance with the present disclosure.

FIG. 8 is a diagram of an example apparatus for wireless communication that supports flexible power classes for wireless transmissions in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples of wireless communications, a user equipment (UE) may transmit, and a network node may receive, one or more wireless messages. For instance, the UE may transmit a wireless message at an output power level enabled by one or more hardware components of the UE (such as one or more power amplifiers (PAs), one or more radio frequency (RF) filters, or one or more antenna elements, among other examples). Such hardware components may determine a permissible (maximum) output power capability of the UE across one or more frequencies. As described herein, the term “permissible” and the term “maximum” may be used interchangeably to describe an upper limit.

While the hardware components of the UE define a maximum output power capability, the UE may transmit wireless messages at an output power level that satisfies the maximum output power capability in accordance with one or more other factors associated with communicating with the network node. For example, the network node may transmit, and the UE may receive, output power configuration that may indicate and/or be indicative of one or more parameters that the UE may use to determine an output power level for wireless transmissions. For instance, the output power configuration may indicate a maximum output power for a frequency carrier of a cell at the network node that the UE communicates with. Additionally, the UE may adjust the output power level in accordance with one or more regulatory and/or exposure metrics associated with a wireless communication environment that the UE resides within. For example, the UE may ensure that an output power level complies with a specific absorption rate (SAR) metric and/or a maximum permissible exposure (MPE) metric in accordance with reducing a total RF exposure experienced by users of the wireless communication environment. Additionally, the UE may adjust the output power level in accordance with a power class of the UE. For example, a wireless communications standard (such a 3^{rd} generation partnership project (3GPP) standard) may categorize the UE as being associated with a power class from a set of power classes. In some examples, the power class associated with the UE may apply a maximum output power limit on the UE in accordance with the hardware components of the UE, the device type of the UE, and/or regulatory compliance of the wireless communication environment. Additionally, the UE may be further associated with one or more maximum power reduction (MPR) values. For example, MPR values may be associated with the power class of the UE, where the UE may apply the MPR value to the power class under one or more conditions. For instance, a UE associated with a power class 3 (PC3) may be configured with a nominal maximum power of 23 decibel-milliwatts (dBm), where the UE applies an MPR value to reduce the maximum power to 21 dBm in accordance with the one or more conditions. The one or more conditions for applying an MPR may include one or more of a modulation scheme in use by the UE, resource allocation of the UE, a subcarrier spacing and/or symbol duration associated with wireless transmissions by the UE, or a dynamic network configuration.

Therefore, the UE may transmit wireless messages at an output power level that satisfies an upper bound maximum output power allowed at the UE (where the upper bound is in compliance with the one or more regulatory and/or exposure metrics, the output power configuration from the network node, the power class of the UE, and/or an MPR value). In some cases, however, the power class associated with the UE (in accordance with the wireless communications standard) may be a fixed power class that may limit the maximum output power capability enabled by the hardware components of the UE. For instance, in accordance with operation across a frequency band, the hardware components of the UE may be calibrated about a center frequency of a frequency band, which may result in the maximum output power capability of the UE being higher at the center frequency of the frequency band compared to an edge frequency of the frequency band. Therefore, the power class may be fixed to an output power that is less than the maximum output power capability of the UE, to enable the UE to transmit across the entire frequency band. In accordance with the power class being fixed lower than the maximum output power capability of the UE, the output power level of the UE may be reduced (even in cases where the UE is capable of an output power above the power class while complying with the one or more regulatory and/or exposure metrics and the parameters set by the network node). Additionally, an MPR value applied to the power class may further reduce the output power level of the UE. Additionally, the UE may select a specific power class with an output power level of P if a maximum output power capability of the UE is within P+/−X dB, where X is a power tolerance (for example, defined by a wireless communications standard). However, the hardware components of the UE may result in a maximum output power capability with a variability greater than +/−X dB. Therefore, the UE would be unable to reach a maximum output power capability enabled by the hardware components. Additionally, power tolerance may be different per power class and/or per frequency band and does not account for different UEs that are associated with different RF capabilities.

Reductions in the output power level resulting from the power class and an associated MPR value may reduce the effectiveness of wireless transmissions from the UE. For example, reduced output power may reduce the uplink transmission range of the UE, reduce the signal quality associated with the UE, or reduce modulation and coding efficiency. Additionally, the reduced output power level may increase an occurrence to uplink retransmissions, which may increase latency and reduce resource utilization between the network node and the UE.

Various aspects relate generally to the UE defining an upper bound of the maximum output power in accordance with a flexible power class value. Some aspects more specifically relate to the UE selecting the flexible power class value from a range of power class values. In some examples, the range of power class values may be configured in accordance with a capability of the UE (such as in accordance with the hardware components). For instance, rather than being associated with a fixed power class, the UE may select from a range of power class values. In some aspects, the UE may select the flexible power class value in accordance with a frequency associated with transmitting a wireless transmission, in accordance with the maximum power capability of the UE at that frequency. In some aspects, the range of power class values may be associated with an upper bound of the maximum output power of the UE. Additionally, the upper bound may further comply with a permissible power level associated with a cell of the network node (as indicated by the network node via configuration information) and/or the one or more regulatory and/or exposure metrics. In some aspects, the UE may be associated with multiple MPR tables, and select an MPR table in accordance with selecting the flexible power class value. In some aspects, the UE may be associated with one or more power offset values and/or one or more permissible (maximum) uplink duty cycle offset values that the UE may apply to the flexible power class value such that the resulting output power level complies with one or more metrics of the wireless communication environment.

Particular aspects of the subject matter described in this disclosure can be implemented to realize one or more of the following potential advantages. In some examples, the described techniques can be used to increase flexibility for the UE selecting the upper bound for the maximum output power. For example, by operating in accordance with a range of power class values, the UE has more freedom in setting an the upper bound in accordance with the hardware components of the UE, rather than limiting the upper bound by a fixed power class. Additionally, the flexible power class value may enable the UE to transmit at a higher output power. Such increases in output power may improve a range of the UE for wireless transmissions, improve the signal quality of the wireless transmissions, increase data throughput of the UE, and reduce interference from nearby wireless devices. Additionally, the increase in output power may reduce an occurrence of uplink retransmissions, which may reduce latency and increase network allocation of resources.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

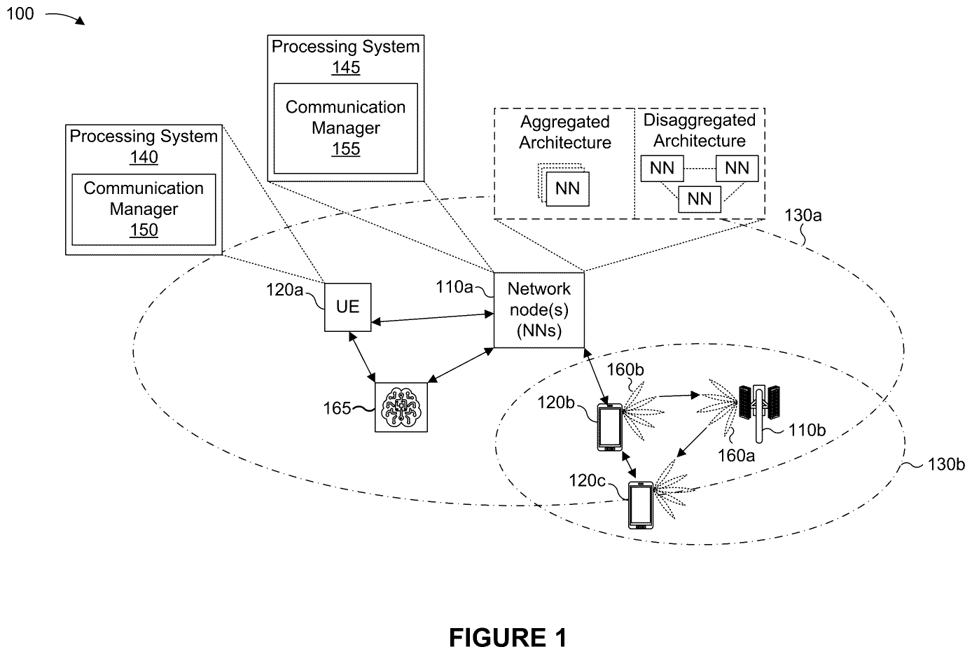

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, in accordance with user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

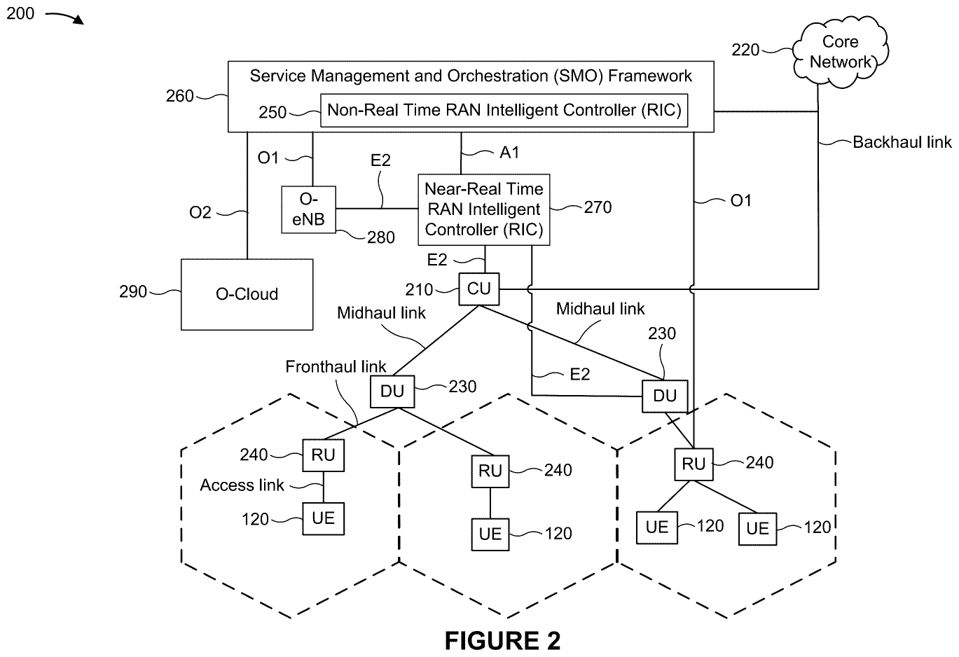

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (JAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder in accordance with, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified in accordance with, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 120 may include a communication manager 150. As described in more detail elsewhere herein, the communication manager 150 may receive, from a network node, configuration information that indicates a plurality of parameters associated with an upper bound for selection of a permissible power parameter, wherein the permissible power parameter is associated with an output power for wireless transmissions to the network node; and transmit, to the network node, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE. Additionally or alternatively, the communication manager 150 may perform one or more other operations described herein.

In some aspects, the network node 110 may include a communication manager 155. As described in more detail elsewhere herein, the communication manager 155 may transmit, to a UE, configuration information that indicates a plurality of parameters associated with an upper bound for selection of a permissible power parameter, wherein the permissible power parameter is associated with an output power for wireless transmissions to the network node; and receive, from the UE, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE. Additionally or alternatively, the communication manager 155 may perform one or more other operations described herein.

FIG. 2 is a diagram illustrating an example disaggregated network node architecture 200 in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

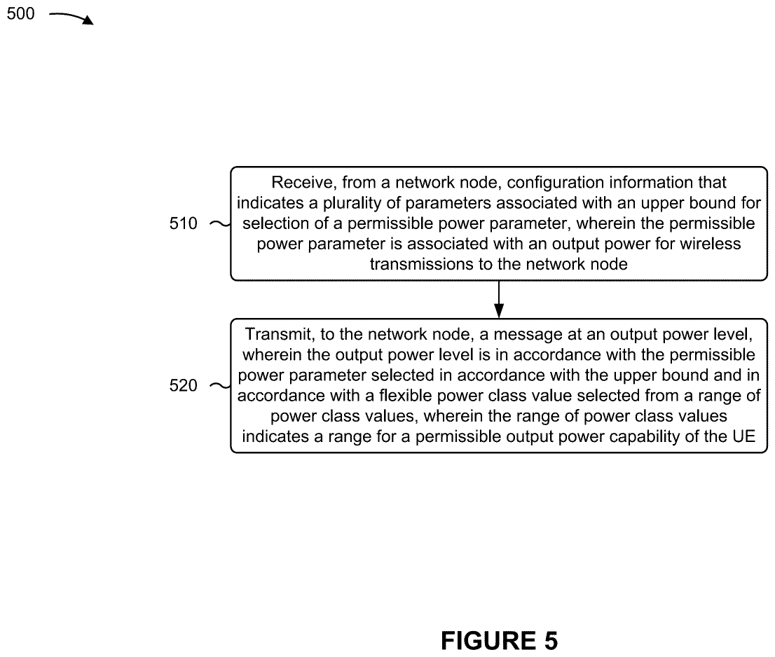

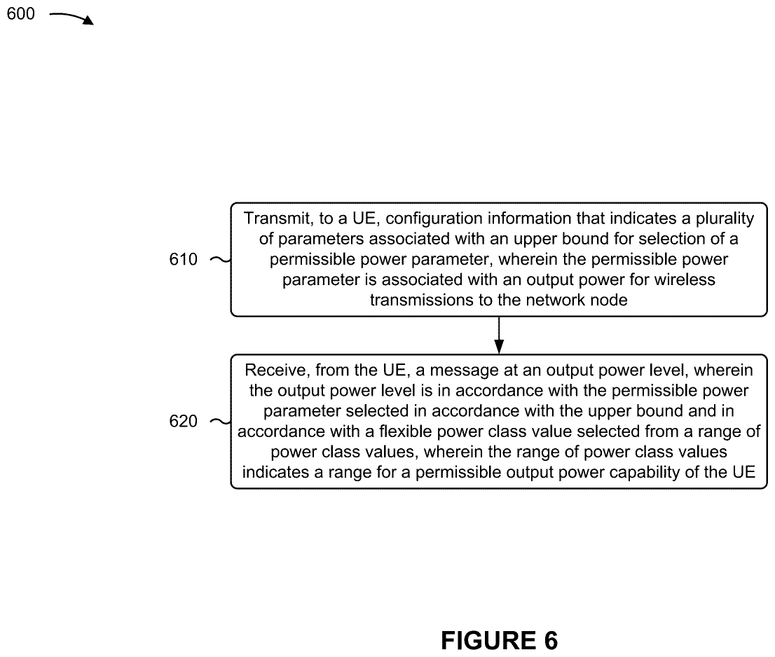

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with flexible power classes for wireless transmissions, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6 or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6 or other processes as described herein. In some examples, executing instructions may include running the instructions, converting the instructions, compiling the instructions, and/or interpreting the instructions, among other examples.

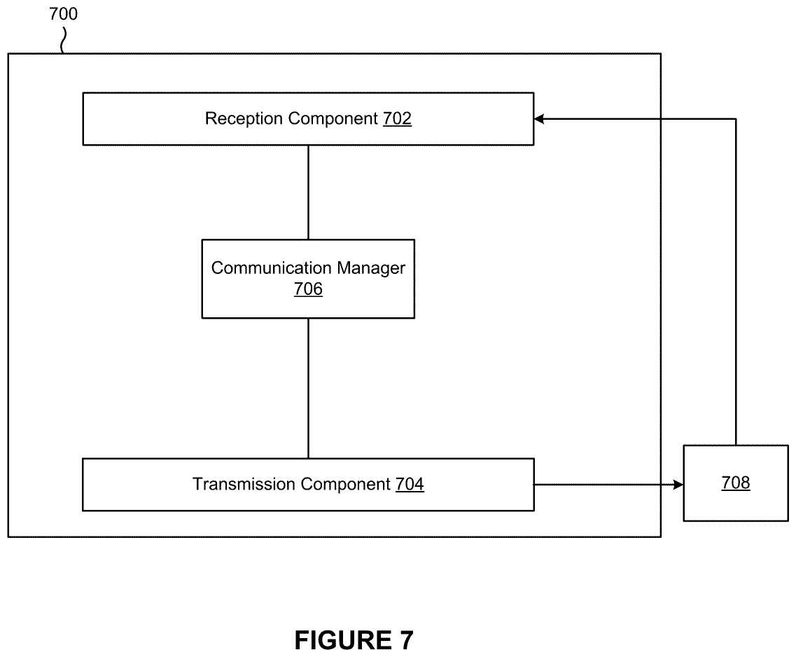

In some aspects, a UE includes means for receiving, from a network node, configuration information that indicates a plurality of parameters associated with an upper bound for selection of a permissible power parameter, wherein the permissible power parameter is associated with an output power for wireless transmissions to the network node; and/or means for transmitting, to the network node, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE. The means for the UE to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

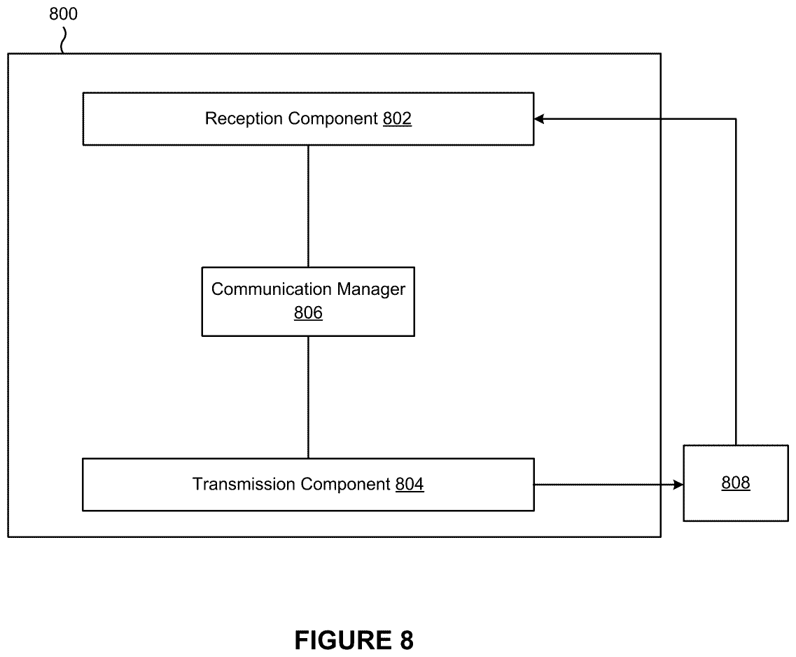

In some aspects, a network node includes means for transmitting, to a UE, configuration information that indicates a plurality of parameters associated with an upper bound for selection of a permissible power parameter, wherein the permissible power parameter is associated with an output power for wireless transmissions to the network node; and/or means for receiving, from the UE, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE. The means for the network node to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

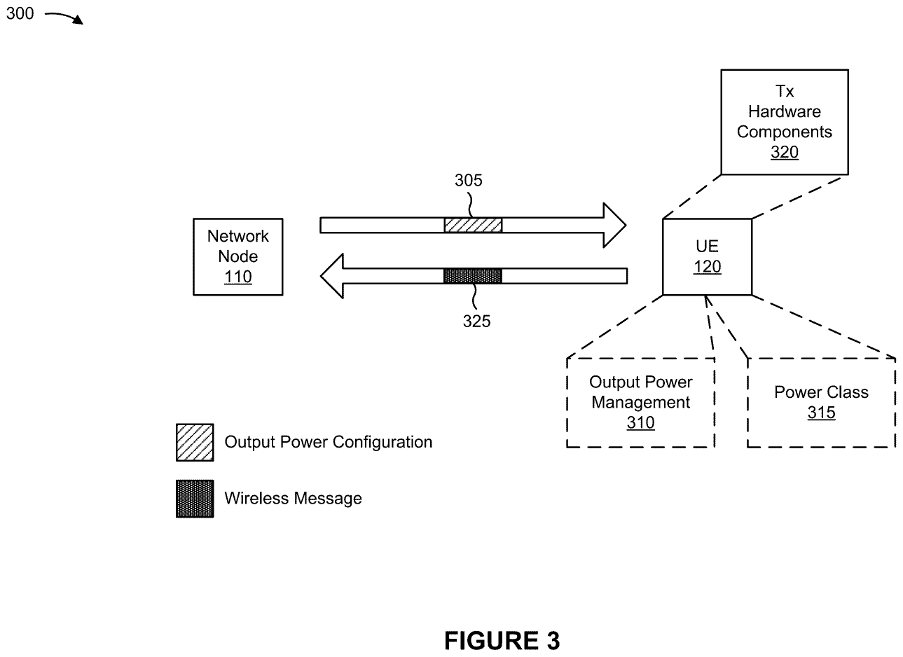

FIG. 3 is a diagram illustrating an example 300 of a wireless device setting a permissible output power in accordance with the present disclosure. In some examples, example 300 may implement or be implemented by one or more aspects of FIGS. 1 and 2. For example, in accordance with example 300, the UE 120 may perform output power management 310 to select and/or determine a permissible (maximum) output power for transmission of a wireless message 325 (e.g., an uplink message) to the network node 110. Additionally, the UE 120 may perform the output power management 310 in accordance with receiving, from the network node 110, an output power configuration 305.

As shown in FIG. 3, the UE 120 may include one or more transmission hardware components associated with performing wireless transmissions. In some examples, the transmission hardware components 320 may include one or more power amplifiers (PAs), one or more RF filters, and/or one or more antenna elements, among other hardware components. A PA may increase the power of a wireless signal before the UE 120 transmits the wireless signal via an antenna. The PA may enable the wireless signal to satisfy transmit power levels as configured in accordance with a power class 315 associated with the UE 120 (described herein). An RF filter may select a frequency band and decrease signaling associated with frequencies not included in the frequency band. Therefore, the RF filter may reduce interference associated with wireless signaling corresponding to frequencies outside of the frequency band. In some examples, the UE 120 may include one or more types of RF filters, including one or more of bandpass filters, low-pass filters, or duplexers. An antenna element may enable the UE 120 to transmit and/or receive signaling that is propagated through free space. For instance, the antenna element may convert electrical signals into electromagnetic waves for the UE 120 to transmit. Therefore, the transmission hardware components 320 may enable the UE 120 to transmit wireless messages 325 to the network node 110.

As shown in FIG. 3, the network node 110 transmits, and the UE 120 receives, the output power configuration 305. For example, the output power configuration 305 may indicate and/or be indicative of one or more parameters that the UE 120 may use to determine an output power for wireless transmissions. In some examples, the output power configuration 305 and the one or more parameters may be indicated via one or more control messages. For example, the one or more control messages may include one or more RRC messages (such as an RRCReconfiguration message), one or more system information messages (such as a master information block (MIB) or SIB, among other examples), one or more MAC messages (such as one or more MAC-CEs), or one or more DCI messages. Examples of the one or more parameters indicated in the output power configuration 305 are described herein.

In addition to the output power configuration 305, the UE 120 may operate in accordance with one or more algorithms to adjust an output power of the wireless messages 325 to satisfy regulatory and/or exposure parameters. For instance, such algorithms at the UE 120 may control an average output power over a given time duration to satisfy a permissible exposure for a wireless communications network associated with example 300. In some examples, the permissible exposure may include RF exposure compliance associated with an SAR compliance and/or an MPE compliance. For instance, SAR may measure a rate at which a human body absorbs RF energy from the UE 120 (for example, expressed in watts per kilogram (W/kg)). Therefore, SAR compliance ensures that the RF energy absorbed by a user of the UE 120 remains within an SAR limit, where the SAR limit may be defined by a regulatory agency (such the Federal Communications Commission (FCC) and/or the International Commission on Non-Ionizing Radiation Protection (ICNIRP)). Additionally, MPE may be the maximum RF power density (PD) to which a user can be exposed over a specific geographic area (for example, measured in watts per square meter (W/m²) or milliwatts per square centimeter (mW/cm²)). Therefore, MPE (or PD) compliance ensures that the RF energy absorbed by a user remains within a PD limit, where the PD limit may be defined by a regulatory agency (such as the FCC and/or ICNIRP). In some examples, SAR and MPE/PD compliance may be combined where a sum of normalized SAR exposure and normalized PD exposure for a user may comply with Equation 1:

$${\sum }_{i = 100 kHz}^{10 GHz} \frac{S A {R}_{i}}{S A {R}_{lim}} + {\sum }_{10 GHz}^{300 GHz} \frac{P {D}_{i}}{P {D}_{lim}} \leq 1 \qquad ( 1 )$$

In addition to complying with the SAR and/or MPE, the UE 120 may set a permissible (maximum) output power associated with transmitting the wireless messages 325 in accordance with performing the output power management 310. For instance, the UE 120 may be enabled and/or allowed to set an associated configured maximum output power P_{CMAX,f,c} for carrier f of serving cell c in each slot. In some examples, carrier f may be a frequency carrier that the UE 120 uses to transmit the wireless messages 325 to serving cell c, where serving cell c may be a part of and/or associated with the network node 110. The UE 120 may set the configured maximum output power P_{CMAX,f,c} within bounds in accordance with Equation 2:

$${P}_{CMAX \_ L , f , c} \leq {P}_{CMAX , f , c} \leq {P}_{CMAX \_ H , f , c} \qquad ( 2 )$$

where P_{CMAX_L,f,c} is a lower bound associated with setting P_{CMAX,f,c} and P_{CMAX_H,f,c} is an upper bound associated with setting P_{CMAX,f,c}. In some examples the UE 120 may determine and/or calculate P_{CMAX,f,c} and P_{CMAX_H,f,c} respectively in accordance with Equation 3 and Equation 4:

$${P}_{CMAX \_ L , f , c} = MIN \{ {P}_{EMAX , c -} Δ {T}_{C , c} , ( {P}_{PowerClass} - Δ {P}_{PowerClass} + Δ {P}_{PowetBoost} ) - MAX ( MAX ( M P {R}_{c} + Δ MP {R}_{c} , A - M P {R}_{c} ) + Δ {T}_{IB , c} + Δ {T}_{C , c} + Δ {T}_{R x S R S} , P - M P {R}_{c} ) \} \qquad ( 3 )$$

$${P}_{CMAX \_ H , f , c} = MIN \{ {P}_{EMAXc} , {P}_{P owerClass} - Δ {P}_{P owerClass} + Δ {P}_{P o werBoost} \} \qquad ( 4 )$$

In some examples, one or more of the parameters included in Equation 3 and Equation 4 may be indicated via the output power configuration 305 and/or a wireless communications standard (such as 3GPP). For example, P_{EMAX,c} may be the value given by one or more fields of an RRC message (such as a p-Max information element (IE) or a field additionalPmax of an NR-NS-PmaxList IE). Additionally, parameter MPR_{c}, parameter P-MPR_{c}, parameter ΔMPR_{c}, and parameter A-MPR_{c} may be associated with shared spectrum access operations according to cell c.

Additionally, P_{PowerClass}, ΔP_{PowerClass}, and ΔP_{PowerBoost} may be associated with a power class 315 of the UE 120. For example, the power class 315 may be from a set of possible power classes (for example, PC3, power class 2 (PC2), power class 1.5 (PC1.5), and power class 1 (PC1)) as defined with reference to a wireless communications standard, such as 3GPP. The power class 315 may be associated with a permissible (maximum) transmit power capability of the UE 120. For instance, PC3 may be associated with a P_{PowerClass} of 23 dBm, PC2 may be associated with a P_{PowerClass} of 26 dBm, PC1.5 may be associated with a P_{PowerClass} of 29 dBm, and PC1 may be associated with a P_{PowerClass} of 31 dBm. Additionally, the ΔP_{PowerClass} may be applicable for single-cell, carrier aggregation (CA), and dual connectivity (DC) configurations, used for fallback to a lower power class. For instance, if the ΔP_{PowerClass} is equal to 3 dB for a PC2 UE 120, then the maximum transmit power capability of the UE 120 is reduced by 3 dB relative to the power class 315. In some examples, the UE 120 may transmit, and the network node 110 may receive, a report that indicates the ΔP_{PowerClass} as part of a power headroom report (PHR). In some examples, the reporting of the ΔP_{PowerClass} may be triggered by a permissible (maximum) uplink duty cycle exceedance or by return to the power class 315 after the permissible uplink duty cycle exceedance. In some examples, the ΔP_{PowerClass} may not be associated with a time duration. In other words, the network node 110 may be unaware of how long the power class 315 is offset by the ΔP_{PowerClass}. Additionally, the power class 315 may be associated with ΔP_{PowerBoost}, which may result in an increase in the maximum transmit power capability of the UE 120. For instance, ΔP_{PowerBoost} is equal to 1 dB for a PC3 UE 120, then the maximum transmit power capability of the UE 120 is increased by 1 dB relative to the P_{PowerClass}. As described herein, each of the parameters included in or associated with Equations 2 through 4 may be described in accordance with a wireless communication standard (such as 3GPP technical specification (TS) 38.101-1, section 6.2.4, version 18.7.0).

As described herein, with reference to Equation 4, the upper bound for the maximum output power (P_{CMAX_H,f,c}) of the UE 120 may be set to accommodate the parameter P_{EMAX,c}. As described herein, the parameter P_{EMAX,c} may be equal to p-Max (for example, if indicated by the network node 110 via the output power configuration 305). In some examples, the value of P_{EMAX,c} may be in compliance with SAR and/or MPE limits. Additionally, the parameter P_{EMAX,c} may reduce excessive uplink power that could interfere with neighboring UEs 120 or network nodes 110 (for example, reduces the likelihood of inter-cell or inter-user interference).

Additionally, with reference to Equation 4, the upper bound for the maximum output power (P_{CMAX_H,f,c}) of the UE 120 may be set to accommodate the power class 315 (P_{PowerClass}, ΔP_{PowerClass}, and ΔP_{PowerBoost}). In some cases, the power class 315 may be a fixed parameter that is limited to an output power that is lower than a maximum output power capability that the UE 120 can achieve across one or more operational conditions. For example, characteristics of the transmission hardware components 320 may result in variability of the maximum power output capability of the UE 120 across a frequency band. In some examples, the RF filter of transmission hardware components 320 may be associated with frequency dependent attenuation, where the attenuation varies across a passband (for example, the frequency range of the filter allows signals to pass through). For instance, RF filters may be configured with reference to a center frequency of a frequency band, where RF filter capability is the most linear and introduces minimal loss at the center frequency. However, near the edge of a frequency band, the RF filter attenuation may increase, which may reduce the amount of power that can pass through the RF filter, decreasing the maximum power capability of the UE 120 at the edges of the frequency band. Additionally, the PA of the transmission hardware components 320 may be associated with varying performance across a frequency band. For instance, the PA may be enabled to deliver a full-rated power at the center frequency of the frequency band; however, at the edges of the frequency band, the PA may be unable to operate in accordance with the full-rate power (for example, due to reduced gain and/or efficiency of the PA). Therefore, the maximum output power capability of the UE 120 may be higher at the center frequency of the frequency band and may be lower at the edges of the frequency band.

To enable the UE 120 to transmit across the entire frequency band, the power class 315 may be set at a power output level lower than an absolute output power capability of the UE 120 (such as at the center frequency of the frequency band). Therefore, in accordance with Equation 4, if P_{EMAX,c} is set higher than the result of P_{PowerClass}−ΔP_{PowerClass}+ΔP_{PowerBoost}, then the upper bound for the maximum output power (P_{CMAX_H,f,c}) of the UE 120 may be limited to the power class 315, even if the UE 120 is capable of transmitting at a higher power while still satisfying P_{EMAX,c}.

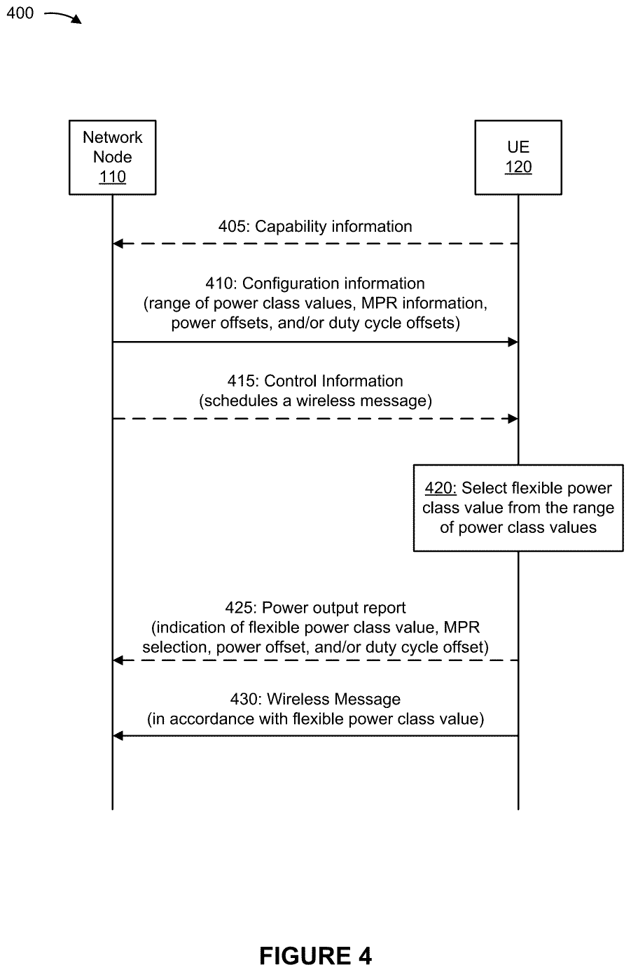

FIG. 4 is a diagram illustrating an example 400 associated with a flexible power class value selection for wireless transmissions in accordance with the present disclosure. Example 400 may implement or be implemented by one or more aspects of FIGS. 1 through 3. For instance, example 400 includes wireless communications between the UE 120 and the network node 110. Alternative examples of the following may be implemented, where some operations are performed in a different order than described, or not described at all. In some cases, one or more operations may include additional features not mentioned below, or further operations may be added. In addition, while example 400 shows operations between the UE 120 and the network node 110, the communications may occur between any quantity of network devices of various types described herein.

In some aspects, as shown by a first operation 405, the UE 120 may optionally transmit, and the network node 110 may receive, capability information. The capability information may be included in a capability report. The UE 120 may transmit the capability information via an uplink communication, a sidelink communication, a unicast communication, a broadcast communication, a UE 120 assistance information (UAI) communication, a UCI communication, a sidelink control information (SCI) communication, a MAC-CE communication, an RRC communication, a PUCCH, a PUSCH, a sidelink channel (for example, a physical sidelink control channel (PSCCH), and/or a physical sidelink shared channel (PSSCH)), among other examples. The capability information may indicate one or more parameters associated with respective capabilities of the UE 120. The one or more parameters may be indicated via respective information elements (IEs) included in the capability report.

The capability information may indicate whether the UE 120 supports a feature and/or one or more parameters related to the feature. For example, the capability information may indicate a capability and/or parameter for supporting selection of an output power level in accordance with a flexible power class value that is different than a fixed power class (such as power class 315, with reference to FIG. 3). That is, the capability information may indicate that the UE 120 is capable of selecting a flexible power class value from a range of power class values in accordance with one or more capabilities of transmission hardware components at the UE 120 (such as transmission hardware components 320). One or more operations described herein may be in accordance with capability information. For example, the UE 120 may perform a communication in accordance with the capability information or may receive configuration information that is in accordance with the capability information.

The network node 110 may determine configuration information for the UE 120 in accordance with the capability information. For example, the network node 110 may determine that the UE 120 is to be configured with a range of power class values rather than a fixed power class. In other examples, the network node 110 may determine the configuration information without, or independently of, the capability information. For example, the network node 110 may determine that the UE 120 is configured with the range of power class values and/or the UE 120 supports the use of a flexible power class value from the range of power class values in accordance with a type, category, or other classification of the UE 120.

In a second operation 410, the network node 110 may transmit, and the UE 120 may receive, the configuration information. In some aspects, the UE 120 may receive the configuration information via one or more of system information signaling (for example, a MIB and/or a SIB, among other examples), RRC signaling, MAC signaling (for example, one or more MAC-CEs), and/or DCI, among other examples. In some examples, the network node 110 may indicate configuration information via multiple signals, where the multiple signals cumulatively indicate the configuration information. In some examples, the configuration information may include one or more parameters included in the output power configuration 305, as described with reference to FIG. 3.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may indicate a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (for example, an original equipment manufacturer (OEM) configuration). In some aspects, the configuration information may include a parameter or index that is indicative of information defined, or otherwise fixed, by a wireless communication standard, such as the 3GPP (for example, rather than explicitly indicating the information).

In some aspects, the configuration information indicates multiple parameters associated with an upper bound selection of a permissible power parameter. In other words, the configuration information may indicate multiple parameters that enable the UE 120 to select the upper bound for the maximum output power (P_{CMAX_H,f,c}) of the UE 120. As shown in FIG. 4, the multiple parameters indicated in the configuration information may include and/or be associated with the range of power class values, MPR information, one or more power offsets, and/or permissible uplink duty cycle offsets. Further discussion of the multiple parameters indicated in the configuration information is provided with reference to one or more other operations of example 400.

In some aspects, the configuration information may indicate a threshold for accessing a cell based on the a flexible power class value selected by the UE 120. For example, if this value is set and indicated to be X dBm and if the UE 120 selects a flexible power class value that is below X dBm, then the UE 120 cannot access and/or may not attempt to access the cell.

In some aspects, as shown by a third operation 415, the network node 110 may optionally transmit, and the UE 120 may receive, control information that schedules transmission of a wireless message. For example, the control information may allocate an uplink grant that schedules the wireless message associated with a first MCS.

In a fourth operation 420, the UE 120 may select the flexible power class value from the range of power class values. In some examples, the UE 120 may use the range of power class values instead of a fixed power class (such as the power class 315). In other words, the UE 120 may refrain from operating in accordance with a fixed power class, and rather the UE 120 may select the upper bound for the maximum output power (P_{CMAX_H,f,c}) in accordance with the range of power class values. In some aspects, the term “flexible power class value” may be alternatively described as “flexible maximum permissible power.” In other words, the flexible maximum permissible power is associated with and/or sets an upper bound on how much the permissible power of the UE 120 can be in a given frequency band and/or a frequency band combination.

In some aspects the network node 110 may not indicate the range of power class values (for example, as part of the configuration information). For example, the UE 120 may select the flexible power class value in accordance with the capabilities of the transmission hardware components associated with the UE.

In some examples, the range of power class values may be associated with a lower bound. For instance, the lower bound of the range of power class values may be associated with P_{CMAX_L,f,c} as described with respect to FIG. 3, in accordance with Equation 3. In some examples, the configuration information may indicate the lower bound of the range of power class values. For instance, the configuration information may indicate the lower bound to be 23 dBm to enable one or more network operations at the network node 110.

In some examples, the range of power class values may not be associated with an upper bound. In other words, the wireless communication standard and/or the configuration information from the network node 110 may not indicate an upper bound for the range of power class values. Instead, the UE 120 may select the upper bound of the range of power class values in accordance with the one or more capabilities of the transmission hardware components of the UE 120. In some examples, the UE 120 may define the upper bound of the range of power class values in accordance with a UE-specific calibration that accounts for chrematistics of the transmission hardware components of the UE 120. For instance, the UE-specific calibration may refer to initial calibration of the transmission hardware components during manufacturing of the UE 120, where the calibration may measure the maximum output power capability of the UE 120 across different conditions (such as different frequency bands and/or different MCSs). Therefore, the upper bound of the range of power class values may be specific to the capabilities of the transmission hardware components, rather than associated with a fixed power class of the UE 120.

Alternatively, the range of power class values may be associated with an upper bound in accordance with parameter P_{CMAX_H,fc}. In some examples, the value of parameter P_{CMAX_H,f,c} may be in accordance with Equation 5:

$${P}_{C M A {X}_{H} , f , c} = {P}_{E M A X} \qquad ( 5 )$$

In some examples, the parameter P_{EMAX} may be set and indicated per cell of the network node 110 in a same frequency band (for example, a respective P_{EMAX,c} for each cell of a set of cells). For example, as part of the configuration information, the network node 110 may indicate P_{EMAX,c} per cell. In some examples, the UE 120 selects P_{EMAX} as the lowest (minimum) P_{EMAX,c} across the set of cells of the network node 110. In some examples, the UE 120 selects P_{EMAX} as the highest (maximum) P_{EMAX,c} across the set of cells of the network node 110. In some examples, the network node 110 may indicate a given P_{EMAX,c} for a given cell via a SIB type-1 (SIB1) associated with the given cell. In some other examples, the configuration information may indicate a P_{EMAX} value that is specific to the UE 120. For example, the network node 110 may transmit, and the UE 120 may receive, the P_{EMAX} value as part of an RRC message (such as an RRCReconfiguration message). In some other examples, if the network node 110 does not indicate the P_{EMAX}, then the wireless communications standard may define a default value for the P_{EMAX} or the UE 120 may select the value of for the P_{EMAX} in accordance with a preference and/or capability of the UE 120. In some other examples, the UE 120 configuration information may indicate a set of values of P_{EMAX} that the UE 120 may select from.

In some examples, the value of a parameter P_{CMAX_H,f,c} may be in accordance with Equation 6:

$${P}_{C M A {X}_{H} , f , c} = min \{ {P}_{E M A X} , {P}_{M A X , r e g u l a t i o n} \} \qquad ( 6 )$$

In some examples, P_{MAX,regulation} may be a parameter set in accordance with one or more characteristics associated with wireless communications between the UE 120 and the network node 110. For example, the P_{MAX,regulation} parameter may be specific to the UE 120 (for example, associated with an identifier of the UE 120), may be specific to a geographic location that the UE 120 resides within, and/or may be specific to a frequency band. In some examples, the P_{MAX,regulation} parameter may be indicated to the UE 120 as part of the configuration information. In some examples, the P_{MAX,regulation} parameter may be indicated to the UE 120 as part of a wireless communications standard.

As described herein, whether the UE 120 selects the upper bound of the maximum output power (P_{CMAX_H,f,c}) in accordance with Equation 5 or in accordance with Equation 6, the upper bound may not be limited and/or reduced relative to a fixed power class (such as the power class 315 and/or in accordance with Equation 4). Instead, the UE 120 may operate in accordance with the range of power class values, providing the UE 120 with more flexibility in selecting the upper bound of the maximum output power while complying with one or more of Equation 5 or Equation 6. In other words, according to the techniques described herein, the upper bound of the maximum output power may not be limited to a fixed power class and an associated power tolerance (for example, as defined in the wireless communications standard).

In some aspects, the lower bound and upper bound (if defined) for the range of power class values may be in accordance with a device type and/or category of the UE 120. For example, the range of power class values for an eMBB type UE 120 may be a first range of power class values (such as [23 dBm, . . . , 35 dBm]) and for an IoT-type UE 120 may be a second range of power class values (such as [14 dBm, . . . , 26 dBm]). Additionally or alternatively, the lower bound and/or upper bound for the range of power class values may be in accordance with a frequency band (for example, may be frequency band dependent). For example, the UE 120 may operate in accordance with a third range of power class values if transmitting a wireless message via a first frequency band, and may operate in accordance with a fourth range of power class values if transmitting a wireless message via a second frequency band. Additionally or alternatively, the lower bound and/or upper bound for the range of power class values may be in accordance with a frequency range (for example, may be frequency range dependent). For example, the UE 120 may operate in accordance with a fifth range of power class values if transmitting a wireless message via FR1, and may operate in accordance with a sixth range of power class values if transmitting a wireless message via a FR2. Therefore, the UE 120 may be associated and/or configured with multiple ranges of power class values (for example, indicated via the configuration information or as part of the wireless communication standard).

In some aspects, the UE 120 may perform multi-carrier operations. For example, the UE 120 may combine multiple frequency bands included in a frequency bandwidth in accordance with CA and/or DC operations. In some aspects of multi-carrier operations, the UE 120 may select a respective flexible power class value from the range of power class values for each frequency band that the UE 120 operates in accordance with. In examples of multi-carrier operations, the power class value associated with the UE 120 may be a sum of the respective flexible power class values across each of the frequency bands used for the multi-carrier operations.

In implementations associated with selecting the output power of the UE 120 in accordance with a fixed power class (such as example 300), different combinations of waveform type, modulation order, and allocation may be associated with different sets of MPR values. For instance, a DFT-s-OFDM waveform with a quadrature phase shift keying (QPSK) modulation and inner allocation may be defined as a 0-dB MPR waveform; then, for each fixed power class, a set of allowed MPRs per modulation order and allocation is defined. However, in accordance with a range of power class values, defining a set of MPRs per power class value may not be scalable. Therefore, as part of selecting the flexible power class value, the UE 120 may additionally select one or more MPR values in accordance with the techniques described herein.

In some aspects, the UE 120 may be associated with one or more MPR tables. In other words, the wireless communications standard may not indicate an association between the one or more MPR tables and the range of power class values. Therefore, the UE 120 may select and/or determine an MPR table from the one or more MPR tables to associate with the selected flexible power class value. In some examples, the UE 120 may transmit, and the network node 110 may receive, a report (in accordance with a fifth operation 425) that indicates the flexible power class value and the associated MPR table. In accordance with association of an MPR table to the selected flexible power class being at the UE 120, different UE 120s may select from the one or more MPR tables independent of one another, enabling more flexibility with selecting an output power per UE 120.

In some aspects, the UE 120 may be associated with multiple MPR tables, where each MPR table of the multiple MPR tables is associated with a respective portion of the range of power class values. For example, if the range of power class values is [23 dBm, . . . , 40 dBm], then the range of power class values may be partitioned into multiple segments (for example, [23 dBm, 29 dBm), [29 dBm, 32 dBm), and [32 dBm to 40 dBm)), where the multiple segments are respectively associated with the multiple MPR tables (for example, [23 dBm, 29 dBm) associated with a first MPR table, [29 dBm, 32 dBm) associated with a second MPR table, and [32 dBm to 40 dBm) associated with a third MPR table). Therefore, if the UE 120 selects the flexible power class parameter that is within [23 dBm, 29 dBm), then the flexible power class parameter is associated with the first MPR table. In some aspects, the network node 110 may indicate to the UE 120 how the range of power class values is partitioned into the multiple segments (for example, via the configuration information or separate control signaling). In some aspects, the wireless communications standard may indicate to the UE 120 how the range of power class values is partitioned into the multiple segments. In some aspects, how the range of power class values is partitioned into the multiple segments may be in accordance with a UE 120 preference and/or capability.

In some aspects, the UE 120 may select one or more MPR values in accordance with scheduling from the network node 110. For example, the UE 120 may select one or more MPR values in accordance with the current uplink grant, as indicated via the third operation 415. For example, the UE 120 may select a first MPR for the current uplink grant that is associated with the first MCS. In some examples, the UE 120 may select one or more additional MPRs for one or more MCSs higher than the first MCS and/or one or more additional MPRs for one or more MCSs lower than the first MCS. For instance, the UE 120 may select one or more second MPRs respectively associated with one or more second MCSs that are lower than the first MCS and/or select one or more third MPRs respectively associated with one or more third MCSs that are higher than the first MCS. In some aspects, the network node 110 may indicate to the UE 120 one or more allowable MPRs per MCS (for example, via the configuration information or separate control signaling). In some aspects, the wireless communications standard may enable the UE 120 to operate in accordance with the one or more allowable MPRs per MCS. In some aspects, the UE 120 may transmit, and the network node 110 may receive, a report (in accordance with a fifth operation 425) that indicates the association between the first MPR and the first MCS, the respective associations between the one or more second MPRs and the one or more second MCSs, and/or the respective associations between the one or more third MPRs and the one or more third MCSs.

In some aspects, the wireless communication standard and/or the configuration information may indicate reverse MPRs (for example, MPRs that increase the maximum output power of the UE 120 rather than reducing the maximum output power). For example, the wireless communication standard and/or the configuration information may indicate to the UE 120 a maximum output power in accordance with a highest modulation order that the UE 120 supports or the highest modulation order currently configured for the UE 120 to use for wireless transmissions and in accordance with an uplink allocation that is below a threshold. In some examples, such a maximum output power may be associated with a worst-case output power scenario at the UE 120. Therefore, the UE 120 may apply a reverse MPR to the worst-case output power scenario to increase the output power by the value of the reverse MPR. In some implementations, each technique associated with an MPR described herein may apply the aspects of the reverse MPR.

As described herein, the UE 120 may operate in accordance with one or more MPR values associated with one or more MPR tables. In some aspects, the allowable MPR values per MPR table may be hardcoded at the UE 120 (as part of an OEM configuration). In some aspects, the wireless communications standard may indicate a set of allowable MPR values per MPR table and the network node 110 may indicate to the UE 120 (via the configuration information) one or more MPR tables in accordance with the set of allowable MPR values indicated in the wireless communication standard. In some aspects, the wireless communications standard may indicate allowable MPR values, the network node 110 may indicate to the UE 120 (via the configuration information) the allowable MPR values, and the UE 120 may transmit to the network node 110 a report (in accordance with the fifth operation 425) that indicates an MPR value selected from the allowable MPR values.

In the fifth operation 425, the UE 120 may optionally transmit, and the network node 110 may receive, a power output report. In some examples, the power output report may include a single report or may include multiple reports that the UE 120 transmits at separate times. As shown in FIG. 4, the power output report may include one or more of an indication of the flexible power class value (for example, selected in accordance with the fourth operation 420), an indication of an MPR value and/or MPR table that is associated with the flexible power class value, an indication of a power offset, or an indication of a permissible uplink duty cycle offset. The power output report may include multiple types of UE 120 reporting, including one or more of a PHR, a UE capability information report, or a measurement report.

In some aspects, the UE 120 may or may not report, to the network node, the selected flexible power class value. Whether the UE 120 reports the selected flexible power class value may be dependent on whether the UE 120 is communicating with a single cell or multiple cells. For example, a UE 120 may not report what the selected flexible power class value is per cell or per frequency band but may report the selected flexible power class value for across a set of frequency bands (for example, the sum of the flexible maximum permissible power across the set of frequency). In examples where the UE 120 reports the selected flexible power class value across the set of frequency bands, the configuration information may indicate the range of power class values at the band combination level (for example, a range of power class values for combining the set of frequency bands).

In some aspects, the UE 120 may indicate the flexible power class value and the associated MPR value, if a threshold percentage of waveforms (X percent) in a set of waveforms can satisfy the power output level that results from the combination of the flexible power class value and the associated MPR value. In some examples, a set of waveforms may include one or more various combinations of waveform type (for example, DFT-s-OFDM or CP-OFDM), modulation order (for example, binary phase shift keying (BPSK), QPSK, 16-QAM, 64-QAM, 256-QAM, 1024-QAM, or 4096-QAM), and allocation type (for example, inner thin or outer thin). Therefore, if a threshold percentage of waveforms (X percent) in the set of waveforms can satisfy the power output level that results from the combination of the flexible power class value and the associated MPR value, then the UE 120 may report the flexible power class value and the associated MPR value. In some examples, the set of waveforms may be indicated as part of the wireless communications standard. In some examples, the set of waveforms may be indicated to the UE 120 from the network node 110 via the configuration information. In some examples, the UE 120 may select the set of waveforms in accordance with a preference and/or a capability. In some examples, the percentage threshold may be set by the wireless communications standard, or may be indicated by the network node 110 via the configuration information. In some examples, the wireless communications standard or the configuration information from the network node 110 may indicate a range or set of threshold percentages (a set of X percentages) where, as part of the power output report, the UE 120 may indicate the threshold percentage (X percent) selected from the range or set of threshold percentages.

In some aspects, the UE 120 may report a flexible power class value in accordance with the flexible power class value supporting a permissible uplink duty cycle percentage that satisfies (for example, is greater than or equal to) a threshold (for example, Y percent). For example, a duty cycle of a UE 120 may be periodic, where each period of the duty cycle includes an active time and an idle time. The active time may be a duration during which the UE 120 may actively transmit and/or receive wireless transmissions. In some examples, the idle time may be a duration during which the UE 120 may refrain from transmitting and/or receiving wireless transmissions. In some examples, the idle time may be a duration during which the UE 120 may fallback to a lower output power. Therefore, a duty cycle percentage may be the percentage of the duty cycle that is the active time. In some aspects, the value of the threshold (Y percent) may be the same across the range of power class values. In some aspects, the value of the threshold (Y percent) may be different for different power class values of the range of power class values. In some aspects, the value of the threshold (Y percent) may be indicated as part of the wireless communications standard and/or indicated by the network node 110 via the configuration information. In some aspects, the UE 120 may set the value of the threshold (Y percent) in accordance with a UE 120 preference and/or capability, where the UE 120 indicates the value of the (Y percent) as part of the report. In some aspects, the UE 120 may operate in accordance with a permissible uplink duty cycle that satisfies the threshold (Y percent) for the frequency band for which the flexible power class value is reported, and in every other frequency band combination that includes that frequency band. In some examples, the UE 120 may operate in accordance with the threshold (Y percent) in the absence of the wireless communications standard indicating an exposure compliance (such as SAR and/or MPE). In other words, the threshold (Y percent) may be a minimum uplink duty cycle percentage that a UE 120 can support while dealing with physical characteristics of the UE 120 (for example, heating and/or leakage).

In some aspects, to comply with exposure characteristics associated with wireless transmissions (such as SAR and/or MPE), the UE 120 may apply a power offset to the flexible power class value. For example, the UE 120 may apply a power-MPR (P-MPR) value to the flexible power class value such that the output power level of the UE 120 resulting from the combination of the flexible power class value and the P-MPR value satisfies an SAR and/or MPE metric associated with the wireless communication environment that the UE 120 resides within. Additionally or alternatively, the UE 120 may apply a permissible uplink duty cycle offset to the permissible uplink duty cycle. For example, the permissible uplink duty cycle offset may reduce the active time associated with the permissible uplink duty cycle such that the output power level of the UE 120 resulting from the flexible power class value in accordance with the reduced active time satisfies the SAR and/or MPE metric associated with the wireless communication environment that the UE 120 resides within. In some aspects, multiple power offsets and/or multiple permissible uplink duty cycle offsets may be respectively indicated for respective power class values of the range of power class values. In some aspects, a single power offset and/or a single permissible uplink duty cycle offset may be indicated for the range of power class values. In some aspects, the one or more power offsets and/or the one or more permissible uplink duty cycle offsets may be indicated as part of the wireless communications standard or indicated by the network node 110 via the configuration information. In some aspects, the UE 120 may select a power offset and/or a permissible uplink duty cycle offset in accordance with a UE 120 preference and/or capability. In some aspects, the UE 120 may indicate, as part of the report, the power offset and/or the permissible uplink duty cycle offset that the UE 120 applies.

If the UE 120 operates in accordance with the multi-carrier operations described herein, the UE 120 may indicate as part of the report the respective flexible power class values selected for each frequency band that is associated with the multi-carrier operations. In some examples, the UE 120 may indicate the respective flexible power class values as separate values, rather than the sum of the respective flexible power class values. Therefore, whether as a default behavior or a capability of the UE 120, the network node 110 may be aware that the UE 120 is able to support the sum of the respective flexible power class values for the associated frequency band combination.

In a sixth operation 430, the UE 120 may transmit, and the network node 110 may receive, a wireless message. The UE 120 may transmit the wireless message at an output power level that is in accordance with the permissible power parameter selected in accordance with the upper bound and in accordance with the flexible power class value selected from a range of power class values. In some aspects, the output power level may be in accordance with one or more other parameters described with respect to example 400 (such as the MPR tables, the power offset value, and/or the duty offset value).

FIG. 5 is a flowchart illustrating an example process 500 performed, for example, at a UE or an apparatus of a UE that supports wireless communications in accordance with the present disclosure. Example process 500 is an example where the apparatus or the UE (for example, UE 120) performs operations associated with flexible power classes for wireless transmissions.

As shown in FIG. 5, in some aspects, process 500 may include receiving, from a network node, configuration information that indicates a plurality of parameters associated with an upper bound for selection of a permissible power parameter, wherein the permissible power parameter is associated with an output power for wireless transmissions to the network node (block 510). For example, the UE (such as by using communication manager 150 or reception component 702, depicted in FIG. 7) may receive, from a network node, configuration information that indicates a plurality of parameters associated with an upper bound for selection of a permissible power parameter, wherein the permissible power parameter is associated with an output power for wireless transmissions to the network node, as described above.

As further shown in FIG. 5, in some aspects, process 500 may include transmitting, to the network node, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE (block 520). For example, the UE (such as by using communication manager 150 or transmission component 704, depicted in FIG. 7) may transmit, to the network node, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE, as described above.

Process 500 may include additional aspects, such as any single aspect or any combination of aspects described below or in connection with one or more other processes described elsewhere herein.

In a first additional aspect, the plurality of parameters includes a permissible power level associated with a cell, and the upper bound is in accordance with the permissible power level.

In a second additional aspect, alone or in combination with the first aspect, the plurality of parameters include a set of permissible power levels respectively associated with a set of cells, and the permissible power level is a lowest permissible power level from the set of permissible power levels respectively associated with the set of cells or is a highest permissible power level from the set of permissible power levels respectively associated with the set of cells.

In a third additional aspect, alone or in combination with one or more of the first and second aspects, process 500 includes receiving, from the network node, signaling that indicates the range of power class values.

In a fourth additional aspect, alone or in combination with one or more of the first through third aspects, the range of power class values is associated with a lower bound and is not associated with an upper bound.

In a fifth additional aspect, alone or in combination with one or more of the first through fourth aspects, the range of power class values is associated with a lower bound and is associated with an upper bound.

In a sixth additional aspect, alone or in combination with one or more of the first through fifth aspects, the range of power class values is in accordance with one or more of a device type associated with the UE, a frequency band associated with the wireless transmissions to the network node, or a frequency range associated with the wireless transmissions to the network node.

In a seventh additional aspect, alone or in combination with one or more of the first through sixth aspects, the UE is associated with one or more MPR tables, the method further comprising transmitting, to the network node, a report that indicates an association between a power class value from the range of power class values and an MPR table from the one or more MPR tables.

In an eighth additional aspect, alone or in combination with one or more of the first through seventh aspects, the range of power class values is partitioned into multiple range segments that respectively span portions of the range of power class values, and the multiple range segments are respectively associated with multiple MPR tables.

In a ninth additional aspect, alone or in combination with one or more of the first through eighth aspects, process 500 includes receiving, from the network node, signaling that indicates the multiple range segments and indicates respective associations between the multiple range segments and the multiple MPR tables.

In a tenth additional aspect, alone or in combination with one or more of the first through ninth aspects, the multiple range segments and respective associations between the multiple range segments and the multiple MPR tables are in accordance with one or more of a preference of the UE or a capability of the UE.

In an eleventh additional aspect, alone or in combination with one or more of the first through tenth aspects, process 500 includes receiving, from the network node, control information that allocates an uplink grant associated with a first MCS, and transmitting, to the network node, a report that indicates one or more of a first MPR value associated with the first MCS of the uplink grant, one or more second MPR values respectively associated with one or more second MCSs lower than the first MCS, or one or more third MPR values respectively associated with one or more third MCSs lower than the first MCS.

In a twelfth additional aspect, alone or in combination with one or more of the first through eleventh aspects, process 500 includes receiving, from the network node, signaling that indicates multiple ranges of MPR values respectively associated with multiple MCSs, wherein one or more of the first MPR value, the one or more second MPR values, or the one or more third MPR values are in accordance with the multiple ranges of MPR values respectively associated with the multiple MCSs.

In a thirteenth additional aspect, alone or in combination with one or more of the first through twelfth aspects, process 500 includes transmitting, to the network node, a report that indicates a power class value from the range of power class values and a MPR value associated with a set of waveforms, wherein the MPR value is indicated in accordance with a combination of the power class value and the MPR value satisfying the permissible power parameter for a threshold percentage of waveforms of the set of waveforms.

In a fourteenth additional aspect, alone or in combination with one or more of the first through thirteenth aspects, process 500 includes receiving, from the network node, signaling that indicates the threshold percentage of waveforms.

In a fifteenth additional aspect, alone or in combination with one or more of the first through fourteenth aspects, process 500 includes receiving, from the network node, signaling that indicates a range of threshold percentages of waveforms that includes the threshold percentage of waveforms, wherein the report indicates the threshold percentages of waveforms.

In a sixteenth additional aspect, alone or in combination with one or more of the first through fifteenth aspects, process 500 includes transmitting, to the network node, a report that indicates a power class value from the range of power class values in accordance with the power class value supporting a duty cycle associated with a duty cycle percentage that satisfies a threshold.

In a seventeenth additional aspect, alone or in combination with one or more of the first through sixteenth aspects, one or more power class values of the range of power class values are respectively associated with one or more thresholds associated with duty cycle percentage.

In an eighteenth additional aspect, alone or in combination with one or more of the first through seventeenth aspects, the threshold associated with the duty cycle percentage is associated with the range of power class values.

In a nineteenth additional aspect, alone or in combination with one or more of the first through eighteenth aspects, process 500 includes receiving, from the network node, signaling that indicates the threshold associated with the duty cycle percentage.

In a twentieth additional aspect, alone or in combination with one or more of the first through nineteenth aspects, the threshold associated with the duty cycle percentage is in accordance with one or more of a preference of the UE or a capability of the UE.

In a twenty-first additional aspect, alone or in combination with one or more of the first through twentieth aspects, the threshold associated with the duty cycle percentage is associated with a frequency band used for transmission of the report and one or more frequency band combinations that include the frequency band.

In a twenty-second additional aspect, alone or in combination with one or more of the first through twenty-first aspects, one or more of the power class values are reduced by a power offset or the duty cycle is reduced by a duty cycle offset in accordance with a permissible exposure parameter associated with the wireless transmissions to the network node.

In a twenty-third additional aspect, alone or in combination with one or more of the first through twenty-second aspects, process 500 includes receiving, from the network node, signaling that indicates one or more of a set of power offsets that includes the power offset or a set of duty cycle offsets that includes the duty cycle offset.

In a twenty-fourth additional aspect, alone or in combination with one or more of the first through twenty-third aspects, one or more of the power offset or the duty cycle offset is in accordance with one or both of a preference of the UE or a capability of the UE.

In a twenty-fifth additional aspect, alone or in combination with one or more of the first through twenty-fourth aspects, the report indicates one or both of the power offset or the duty cycle offset.

Although FIG. 5 shows example blocks of process 500, in some aspects, process 500 may include additional blocks, fewer blocks, different blocks, or differently arranged blocks than those depicted in FIG. 5. Additionally or alternatively, two or more of the blocks of process 500 may be performed in parallel.

FIG. 6 is a flowchart illustrating an example process 600 performed, for example, at a network node or an apparatus of a network node that supports wireless communications in accordance with the present disclosure. Example process 600 is an example where the apparatus or the network node (for example, network node 110) performs operations associated with flexible power classes for wireless transmissions.

As shown in FIG. 6, in some aspects, process 600 may include transmitting, to a UE, configuration information that indicates a plurality of parameters associated with an upper bound for selection of a permissible power parameter, wherein the permissible power parameter is associated with an output power for wireless transmissions to the network node (block 610). For example, the network node (such as by using communication manager 150 or transmission component 804, depicted in FIG. 8) may transmit, to a UE, configuration information that indicates a plurality of parameters associated with an upper bound for selection of a permissible power parameter, wherein the permissible power parameter is associated with an output power for wireless transmissions to the network node, as described above.

As further shown in FIG. 6, in some aspects, process 600 may include receiving, from the UE, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE (block 620). For example, the network node (such as by using communication manager 150 or reception component 802, depicted in FIG. 8) may receive, from the UE, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE, as described above.

Process 600 may include additional aspects, such as any single aspect or any combination of aspects described below or in connection with one or more other processes described elsewhere herein.

In a first additional aspect, the plurality of parameters includes a permissible power level associated with a cell, and the upper bound is in accordance with the permissible power level.

In a second additional aspect, alone or in combination with the first aspect, process 600 includes the plurality of parameters include a set of permissible power levels respectively associated with a set of cells, and the permissible power level is a lowest permissible power level from the set of permissible power levels respectively associated with the set of cells or is a highest permissible power level from the set of permissible power levels respectively associated with the set of cells.

In a third additional aspect, alone or in combination with one or more of the first and second aspects, process 600 includes transmitting, to the UE, signaling that indicates the range of power class values.

In a fourth additional aspect, alone or in combination with one or more of the first through third aspects, the range of power class values is associated with a lower bound and is not associated with an upper bound.

In a fifth additional aspect, alone or in combination with one or more of the first through fourth aspects, the range of power class values is associated with a lower bound and is associated with an upper bound.

In a sixth additional aspect, alone or in combination with one or more of the first through fifth aspects, the range of power class values is in accordance with one or more of a device type associated with the UE, a frequency band associated with the wireless transmissions to the network node, or a frequency range associated with the wireless transmissions to the network node.

In a seventh additional aspect, alone or in combination with one or more of the first through sixth aspects, the UE is associated with one or more MPR tables, and process 600 includes receiving, from the UE, a report that indicates an association between a power class value from the range of power class values and an MPR table from the one or more MPR tables.

In an eighth additional aspect, alone or in combination with one or more of the first through seventh aspects, the range of power class values is partitioned into multiple range segments that respectively span portions of the range of power class values, and the multiple range segments are respectively associated with multiple MPR tables.

In a ninth additional aspect, alone or in combination with one or more of the first through eighth aspects, process 600 includes transmitting, to the UE, signaling that indicates the multiple range segments and indicates respective associations between the multiple range segments and the multiple MPR tables.

In a tenth additional aspect, alone or in combination with one or more of the first through ninth aspects, the multiple range segments and an association between the multiple range segments and the respective multiple MPR tables are in accordance with one or more of a preference of the UE or a capability of the UE.

In an eleventh additional aspect, alone or in combination with one or more of the first through tenth aspects, process 600 includes transmitting, to the UE, control information that allocates an uplink grant associated with a first MCS, and receiving, from the UE, a report that indicates one or more of a first MPR value associated with the first MCS of the uplink grant, one or more second MPR values respectively associated with one or more second MCSs lower than the first MCS, or one or more third MPR values respectively associated with one or more third MCSs lower than the first MCS.

In a twelfth additional aspect, alone or in combination with one or more of the first through eleventh aspects, process 600 includes transmitting, to the UE, signaling that indicates multiple ranges of MPR values respectively associated with multiple MCSs, wherein one or more of the first MPR value, the one or more second MPR values, or the one or more third MPR values are in accordance with the multiple ranges of MPR values respectively associated with the multiple MCSs.

In a thirteenth additional aspect, alone or in combination with one or more of the first through twelfth aspects, process 600 includes receiving, from the UE, a report that indicates a power class value from the range of power class values and a MPR value associated with a set of waveforms, wherein the MPR value is indicated in accordance with a combination of the power class value and the MPR value satisfying the permissible power parameter for a threshold percentage of waveforms of the set of waveforms.

In a fourteenth additional aspect, alone or in combination with one or more of the first through thirteenth aspects, process 600 includes transmitting, to the UE, signaling that indicates the threshold percentage of waveforms.

In a fifteenth additional aspect, alone or in combination with one or more of the first through fourteenth aspects, process 600 includes transmitting, to the UE, signaling that indicates a range of threshold percentages of waveforms that includes the threshold percentage of waveforms, wherein the report indicates the threshold percentages of waveforms.

In a sixteenth additional aspect, alone or in combination with one or more of the first through fifteenth aspects, process 600 includes receiving, from the UE, a report that indicates a power class value from the range of power class values in accordance with the power class value supporting a duty cycle associated with a duty cycle percentage that satisfies a threshold.

In a seventeenth additional aspect, alone or in combination with one or more of the first through sixteenth aspects, one or more power class values of the range of power class values are respectively associated with one or more thresholds associated with duty cycle percentage.

In an eighteenth additional aspect, alone or in combination with one or more of the first through seventeenth aspects, the threshold associated with the duty cycle percentage is associated with the range of power class values.

In a nineteenth additional aspect, alone or in combination with one or more of the first through eighteenth aspects, process 600 includes transmitting, to the UE, signaling that indicates the threshold associated with duty cycle percentage.

In a twentieth additional aspect, alone or in combination with one or more of the first through nineteenth aspects, the threshold associated with the duty cycle percentage is in accordance with one or more of a preference of the UE or a capability of the UE.

In a twenty-first additional aspect, alone or in combination with one or more of the first through twentieth aspects, the threshold associated with the duty cycle percentage is associated with a frequency band used for transmission of the report and one or more frequency band combinations that include the frequency band.

In a twenty-second additional aspect, alone or in combination with one or more of the first through twenty-first aspects, one or more of the power class values are reduced by a power offset or the duty cycle is reduced by a duty cycle offset in accordance with a permissible exposure parameter associated with the wireless transmissions to the network node.

In a twenty-third additional aspect, alone or in combination with one or more of the first through twenty-second aspects, process 600 includes transmitting, to the UE, signaling that indicates one or more of a set of power offsets that include the power offset or a set of duty cycle offsets that include the duty cycle offset.

In a twenty-fourth additional aspect, alone or in combination with one or more of the first through twenty-third aspects, one or more of the power offset or the duty cycle offset is in accordance with one or both of a preference of the UE or a capability of the UE.

In a twenty-fifth additional aspect, alone or in combination with one or more of the first through twenty-fourth aspects, the report indicates one or both of the power offset or the duty cycle offset.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a diagram of an example apparatus 700 for wireless communication that supports flexible power classes for wireless transmissions in accordance with the present disclosure. The apparatus 700 may be a UE, or a UE may include the apparatus 700. In some aspects, the apparatus 700 includes a reception component 702, a transmission component 704, and a communication manager 706, which may be in communication with one another (for example, via one or more buses). As shown, the apparatus 700 may communicate with another apparatus 708 (such as a UE 120, a network node 110, or another wireless communication device) using the reception component 702 and the transmission component 704. The communication manager 706 may be included in, or implemented via, a processing system (for example, the processing system 140). In some aspects, the communication manager 706 is the communication manager 150.

In some aspects, the apparatus 700 may be configured to and/or operable to perform one or more operations described herein in connection with FIGS. 3 and 4. Additionally or alternatively, the apparatus 700 may be configured to and/or operable to perform one or more processes described herein, such as process 500 of FIG. 5.

The reception component 702 may receive communications, such as reference signals, control information, and/or data communications, from the apparatus 708. The reception component 702 may provide received communications to one or more other components of the apparatus 700, such as the communication manager 706. In some aspects, the reception component 702 may perform signal processing on the received communications, and may provide the processed signals to the one or more other components in a similar manner as described above in connection with FIG. 1. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, and/or data communications, to the apparatus 708. In some aspects, the communication manager 706 may generate communications and may transmit the generated communications to the transmission component 704 for transmission to the apparatus 708. In some aspects, the transmission component 704 may perform signal processing on the generated communications, and may transmit the processed signals to the apparatus 708 in a similar manner as described above in connection with FIG. 1. In some aspects, the transmission component 704 may include one or more components of the UE described above in connection with FIG. 1, such as a radio, one or more RF chains, one or more transceivers, or one or more modems, each of which may in turn be coupled with one or more antennas of the UE. In some aspects, the transmission component 704 may be co-located with the reception component 702.

The communication manager 706 may receive or may cause the reception component 702 to receive, from a network node, configuration information that indicates a plurality of parameters associated with an upper bound for selection of a permissible power parameter, wherein the permissible power parameter is associated with an output power for wireless transmissions to the network node. The communication manager 706 may transmit or may cause the transmission component 704 to transmit, to the network node, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE. In some aspects, the communication manager 706 may perform one or more operations described elsewhere herein as being performed by one or more components of the communication manager 706.

In some aspects, the communication manager 706 includes a set of components. Alternatively, the set of components may be separate and distinct from the communication manager 706. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 702 may receive, from a network node, configuration information that indicates a plurality of parameters associated with an upper bound for selection of a permissible power parameter, wherein the permissible power parameter is associated with an output power for wireless transmissions to the network node. The transmission component 704 may transmit, to the network node, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE.

The reception component 702 may receive, from the network node, signaling that indicates the range of power class values.

The reception component 702 may receive, from the network node, signaling that indicates the multiple range segments and indicates respective associations between the multiple range segments and the multiple MPR tables.

The reception component 702 may receive, from the network node, control information that allocates an uplink grant associated with a first MCS.

The transmission component 704 may transmit, to the network node, a report that indicates one or more of a first MPR value associated with the first MCS of the uplink grant, one or more second MPR values respectively associated with one or more second MCSs lower than the first MCS, or one or more third MPR values respectively associated with one or more third MCSs lower than the first MCS.

The reception component 702 may receive, from the network node, signaling that indicates multiple ranges of MPR values respectively associated with multiple MCSs, wherein one or more of the first MPR value, the one or more second MPR values, or the one or more third MPR values are in accordance with the multiple ranges of MPR values respectively associated with the multiple MCSs.

The transmission component 704 may transmit, to the network node, a report that indicates a power class value from the range of power class values and a MPR value associated with a set of waveforms, wherein the MPR value is indicated in accordance with a combination of the power class value and the MPR value satisfying the permissible power parameter for a threshold percentage of waveforms of the set of waveforms.

The reception component 702 may receive, from the network node, signaling that indicates the threshold percentage of waveforms.

The reception component 702 may receive, from the network node, signaling that indicates a range of threshold percentages of waveforms that includes the threshold percentage of waveforms, wherein the report indicates the threshold percentages of waveforms.

The transmission component 704 may transmit, to the network node, a report that indicates a power class value from the range of power class values in accordance with the power class value supporting a duty cycle associated with a duty cycle percentage that satisfies a threshold.

The reception component 702 may receive, from the network node, signaling that indicates the threshold associated with the duty cycle percentage.

The reception component 702 may receive, from the network node, signaling that indicates one or more of a set of power offsets that includes the power offset or a set of duty cycle offsets that includes the duty cycle offset.

The quantity and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

FIG. 8 is a diagram of an example apparatus 800 for wireless communication that supports flexible power classes for wireless transmissions in accordance with the present disclosure. The apparatus 800 may be a network node, or a network node may include the apparatus 800. In some aspects, the apparatus 800 includes a reception component 802, a transmission component 804, and a communication manager 806, which may be in communication with one another (for example, via one or more buses). As shown, the apparatus 800 may communicate with another apparatus 808 (such as a UE 120, a network node 110, or another wireless communication device) using the reception component 802 and the transmission component 804. The communication manager 806 may be included in, or implemented via, a processing system (for example, the processing system 145). In some aspects, the communication manager 806 is the communication manager 155

In some aspects, the apparatus 800 may be configured to and/or operable to perform one or more operations described herein in connection with FIGS. 3 and 4. Additionally or alternatively, the apparatus 800 may be configured to and/or operable to perform one or more processes described herein, such as process 600 of FIG. 6.

The reception component 802 may receive communications, such as reference signals, control information, and/or data communications, from the apparatus 808. The reception component 802 may provide received communications to one or more other components of the apparatus 800, such as the communication manager 806. In some aspects, the reception component 802 may perform signal processing on the received communications, and may provide the processed signals to the one or more other components in a similar manner as described above in connection with FIG. 1. In some aspects, the reception component 802 may include one or more components of the network node described above in connection with FIG. 1, such as a radio, one or more RF chains, one or more transceivers, or one or more modems, each of which may in turn be coupled with one or more antennas of the network node.

The transmission component 804 may transmit communications, such as reference signals, control information, and/or data communications, to the apparatus 808. In some aspects, the communication manager 806 may generate communications and may transmit the generated communications to the transmission component 804 for transmission to the apparatus 808. In some aspects, the transmission component 804 may perform signal processing on the generated communications, and may transmit the processed signals to the apparatus 808 in a similar manner as described above in connection with FIG. 1. In some aspects, the transmission component 804 may include one or more components of the network node described above in connection with FIG. 1, such as a radio, one or more RF chains, one or more transceivers, or one or more modems, each of which may in turn be coupled with one or more antennas of the network node. In some aspects, the transmission component 804 may be co-located with the reception component 802.

The communication manager 806 may transmit or may cause the transmission component 804 to transmit, to a UE, configuration information that indicates a plurality of parameters associated with an upper bound for selection of a permissible power parameter, wherein the permissible power parameter is associated with an output power for wireless transmissions to the network node. The communication manager 806 may receive, or may cause the reception component 802 to receive, from the UE, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE. In some aspects, the communication manager 806 may perform one or more operations described elsewhere herein as being performed by one or more components of the communication manager 806.

In some aspects, the communication manager 806 includes a set of components. Alternatively, the set of components may be separate and distinct from the communication manager 806. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The transmission component 804 may transmit, to a UE, configuration information that indicates a plurality of parameters associated with an upper bound for selection of a permissible power parameter, wherein the permissible power parameter is associated with an output power for wireless transmissions to the network node. The reception component 802 may receive, from the UE, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE.

The transmission component 804 may transmit, to the UE, signaling that indicates the range of power class values.

The transmission component 804 may transmit, to the UE, signaling that indicates the multiple range segments and indicates respective associations between the multiple range segments and the multiple MPR tables.

The transmission component 804 may transmit, to the UE, control information that allocates an uplink grant associated with a first MCS.

The reception component 802 may receive, from the UE, a report that indicates one or more of a first MPR value associated with the first MCS of the uplink grant, one or more second MPR values respectively associated with one or more second MCSs lower than the first MCS, or one or more third MPR values respectively associated with one or more third MCSs lower than the first MCS.

The transmission component 804 may transmit, to the UE, signaling that indicates multiple ranges of MPR values respectively associated with multiple MCSs, wherein one or more of the first MPR value, the one or more second MPR values, or the one or more third MPR values are in accordance with the multiple ranges of MPR values respectively associated with the multiple MCSs.

The reception component 802 may receive, from the UE, a report that indicates a power class value from the range of power class values and a MPR value associated with a set of waveforms, wherein the MPR value is indicated in accordance with a combination of the power class value and the MPR value satisfying the permissible power parameter for a threshold percentage of waveforms of the set of waveforms.

The transmission component 804 may transmit, to the UE, signaling that indicates the threshold percentage of waveforms.

The transmission component 804 may transmit, to the UE, signaling that indicates a range of threshold percentages of waveforms that includes the threshold percentage of waveforms, wherein the report indicates the threshold percentages of waveforms.

The reception component 802 may receive, from the UE, a report that indicates a power class value from the range of power class values in accordance with the power class value supporting a duty cycle associated with a duty cycle percentage that satisfies a threshold.

The transmission component 804 may transmit, to the UE, signaling that indicates the threshold associated with duty cycle percentage.

The transmission component 804 may transmit, to the UE, signaling that indicates one or more of a set of power offsets that include the power offset or a set of duty cycle offsets that include the duty cycle offset.

The quantity and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: receiving, from a network node, configuration information that indicates a plurality of parameters associated with an upper bound for selection of a permissible power parameter, wherein the permissible power parameter is associated with an output power for wireless transmissions to the network node; and transmitting, to the network node, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE.

Aspect 2: The method of Aspect 1, wherein the plurality of parameters includes a permissible power level associated with a cell, and wherein the upper bound is in accordance with the permissible power level.

Aspect 3: The method of Aspect 2, wherein: the plurality of parameters include a set of permissible power levels respectively associated with a set of cells, and the permissible power level is a lowest permissible power level from the set of permissible power levels respectively associated with the set of cells or is a highest permissible power level from the set of permissible power levels respectively associated with the set of cells.

Aspect 4: The method of any of Aspects 1-3, further comprising: receiving, from the network node, signaling that indicates the range of power class values.

Aspect 5: The method of any of Aspects 1-4, wherein the range of power class values is associated with a lower bound and is not associated with an upper bound.

Aspect 6: The method of any of Aspects 1-5, wherein the range of power class values is associated with a lower bound and is associated with an upper bound.

Aspect 7: The method of any of Aspects 1-6, wherein the range of power class values is in accordance with one or more of a device type associated with the UE, a frequency band associated with the wireless transmissions to the network node, or a frequency range associated with the wireless transmissions to the network node.

Aspect 8: The method of any of Aspects 1-7, wherein the UE is associated with one or more maximum power reduction (MPR) tables, the method further comprising: transmitting, to the network node, a report that indicates an association between a power class value from the range of power class values and an MPR table from the one or more MPR tables.

Aspect 9: The method of any of Aspects 1-8, wherein the range of power class values is partitioned into multiple range segments that respectively span portions of the range of power class values, and wherein the multiple range segments are respectively associated with multiple maximum power reduction (MPR) tables.

Aspect 10: The method of Aspect 9, further comprising: receiving, from the network node, signaling that indicates the multiple range segments and indicates respective associations between the multiple range segments and the multiple MPR tables.

Aspect 11: The method of Aspect 9, wherein the multiple range segments and respective associations between the multiple range segments and the multiple MPR tables are in accordance with one or more of a preference of the UE or a capability of the UE.

Aspect 12: The method of any of Aspects 1-11, further comprising: receiving, from the network node, control information that allocates an uplink grant associated with a first modulation and coding scheme (MCS); and transmitting, to the network node, a report that indicates one or more of a first maximum power reduction (MPR) value associated with the first MCS of the uplink grant, one or more second MPR values respectively associated with one or more second MCSs lower than the first MCS, or one or more third MPR values respectively associated with one or more third MCSs lower than the first MCS.

Aspect 13: The method of Aspect 12, further comprising: receiving, from the network node, signaling that indicates multiple ranges of MPR values respectively associated with multiple MCSs, wherein one or more of the first MPR value, the one or more second MPR values, or the one or more third MPR values are in accordance with the multiple ranges of MPR values respectively associated with the multiple MCSs.

Aspect 14: The method of any of Aspects 1-13, further comprising: transmitting, to the network node, a report that indicates a power class value from the range of power class values and a maximum power reduction (MPR) value associated with a set of waveforms, wherein the MPR value is indicated in accordance with a combination of the power class value and the MPR value satisfying the permissible power parameter for a threshold percentage of waveforms of the set of waveforms.

Aspect 15: The method of Aspect 14, further comprising: receiving, from the network node, signaling that indicates the threshold percentage of waveforms.

Aspect 16: The method of Aspect 14, further comprising: receiving, from the network node, signaling that indicates a range of threshold percentages of waveforms that includes the threshold percentage of waveforms, wherein the report indicates the threshold percentages of waveforms.

Aspect 17: The method of any of Aspects 1-16, further comprising: transmitting, to the network node, a report that indicates a power class value from the range of power class values in accordance with the power class value supporting a duty cycle associated with a duty cycle percentage that satisfies a threshold.

Aspect 18: The method of Aspect 17, wherein one or more power class values of the range of power class values are respectively associated with one or more thresholds associated with duty cycle percentage.

Aspect 19: The method of Aspect 17, wherein the threshold associated with the duty cycle percentage is associated with the range of power class values.

Aspect 20: The method of Aspect 17, further comprising: receiving, from the network node, signaling that indicates the threshold associated with the duty cycle percentage.

Aspect 21: The method of Aspect 17, wherein the threshold associated with the duty cycle percentage is in accordance with one or more of a preference of the UE or a capability of the UE.

Aspect 22: The method of Aspect 17, wherein the threshold associated with the duty cycle percentage is associated with a frequency band used for transmission of the report and one or more frequency band combinations that include the frequency band.

Aspect 23: The method of Aspect 17, wherein one or more of the power class values are reduced by a power offset or the duty cycle is reduced by a duty cycle offset in accordance with a permissible exposure parameter associated with the wireless transmissions to the network node.

Aspect 24: The method of Aspect 23, further comprising: receiving, from the network node, signaling that indicates one or more of a set of power offsets that includes the power offset or a set of duty cycle offsets that includes the duty cycle offset.

Aspect 25: The method of Aspect 23, wherein one or more of the power offset or the duty cycle offset is in accordance with one or both of a preference of the UE or a capability of the UE.

Aspect 26: The method of Aspect 23, wherein the report indicates one or both of the power offset or the duty cycle offset.

Aspect 27: A method of wireless communication performed by a network node, comprising: transmitting, to a user equipment (UE), configuration information that indicates a plurality of parameters associated with an upper bound for selection of a permissible power parameter, wherein the permissible power parameter is associated with an output power for wireless transmissions to the network node; and receiving, from the UE, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE.

Aspect 28: The method of Aspect 27, wherein the plurality of parameters includes a permissible power level associated with a cell, and wherein the upper bound is in accordance with the permissible power level.

Aspect 29: The method of Aspect 28, wherein: the plurality of parameters include a set of permissible power levels respectively associated with a set of cells, and the permissible power level is a lowest permissible power level from the set of permissible power levels respectively associated with the set of cells or is a highest permissible power level from the set of permissible power levels respectively associated with the set of cells.

Aspect 30: The method of any of Aspects 27-29, further comprising: transmitting, to the UE, signaling that indicates the range of power class values.

Aspect 31: The method of any of Aspects 27-30, wherein the range of power class values is associated with a lower bound and is not associated with an upper bound.

Aspect 32: The method of any of Aspects 27-31, wherein the range of power class values is associated with a lower bound and is associated with an upper bound.

Aspect 33: The method of any of Aspects 27-32, wherein the range of power class values is in accordance with one or more of a device type associated with the UE, a frequency band associated with the wireless transmissions to the network node, or a frequency range associated with the wireless transmissions to the network node.

Aspect 34: The method of any of Aspects 27-33, wherein the UE is associated with one or more maximum power reduction (MPR) tables, the method further comprising: receiving, from the UE, a report that indicates an association between a power class value from the range of power class values and an MPR table from the one or more MPR tables.

Aspect 35: The method of any of Aspects 27-34, wherein the range of power class values is partitioned into multiple range segments that respectively span portions of the range of power class values, and wherein the multiple range segments are respectively associated with multiple maximum power reduction (MPR) tables.

Aspect 36: The method of Aspect 35, further comprising: transmitting, to the UE, signaling that indicates the multiple range segments and indicates respective associations between the multiple range segments and the multiple MPR tables.

Aspect 37: The method of Aspect 35, wherein the multiple range segments and an association between the multiple range segments and the respective multiple MPR tables are in accordance with one or more of a preference of the UE or a capability of the UE.

Aspect 38: The method of any of Aspects 27-37, further comprising: transmitting, to the UE, control information that allocates an uplink grant associated with a first modulation and coding scheme (MCS); and receiving, from the UE, a report that indicates one or more of a first maximum power reduction (MPR) value associated with the first MCS of the uplink grant, one or more second MPR values respectively associated with one or more second MCSs lower than the first MCS, or one or more third MPR values respectively associated with one or more third MCSs lower than the first MCS.

Aspect 39: The method of Aspect 38, further comprising: transmitting, to the UE, signaling that indicates multiple ranges of MPR values respectively associated with multiple MCSs, wherein one or more of the first MPR value, the one or more second MPR values, or the one or more third MPR values are in accordance with the multiple ranges of MPR values respectively associated with the multiple MCSs.

Aspect 40: The method of any of Aspects 27-39, further comprising: receiving, from the UE, a report that indicates a power class value from the range of power class values and a maximum power reduction (MPR) value associated with a set of waveforms, wherein the MPR value is indicated in accordance with a combination of the power class value and the MPR value satisfying the permissible power parameter for a threshold percentage of waveforms of the set of waveforms.

Aspect 41: The method of Aspect 40, further comprising: transmitting, to the UE, signaling that indicates the threshold percentage of waveforms.

Aspect 42: The method of Aspect 40, further comprising: transmitting, to the UE, signaling that indicates a range of threshold percentages of waveforms that includes the threshold percentage of waveforms, wherein the report indicates the threshold percentages of waveforms.

Aspect 43: The method of any of Aspects 27-42, further comprising: receiving, from the UE, a report that indicates a power class value from the range of power class values in accordance with the power class value supporting a duty cycle associated with a duty cycle percentage that satisfies a threshold.

Aspect 44: The method of Aspect 43, wherein one or more power class values of the range of power class values are respectively associated with one or more thresholds associated with duty cycle percentage.

Aspect 45: The method of Aspect 43, wherein the threshold associated with the duty cycle percentage is associated with the range of power class values.

Aspect 46: The method of Aspect 43, further comprising: transmitting, to the UE, signaling that indicates the threshold associated with duty cycle percentage.

Aspect 47: The method of Aspect 43, wherein the threshold associated with the duty cycle percentage is in accordance with one or more of a preference of the UE or a capability of the UE.

Aspect 48: The method of Aspect 43, wherein the threshold associated with the duty cycle percentage is associated with a frequency band used for transmission of the report and one or more frequency band combinations that include the frequency band.

Aspect 49: The method of Aspect 43, wherein one or more of the power class values are reduced by a power offset or the duty cycle is reduced by a duty cycle offset in accordance with a permissible exposure parameter associated with the wireless transmissions to the network node.

Aspect 50: The method of Aspect 49, further comprising: transmitting, to the UE, signaling that indicates one or more of a set of power offsets that include the power offset or a set of duty cycle offsets that include the duty cycle offset.

Aspect 51: The method of Aspect 49, wherein one or more of the power offset or the duty cycle offset is in accordance with one or both of a preference of the UE or a capability of the UE.

Aspect 52: The method of Aspect 49, wherein the report indicates one or both of the power offset or the duty cycle offset.

Aspect 53: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-52.

Aspect 54: An apparatus for wireless communication at a device, the apparatus comprising one or more memories and one or more processors coupled to the one or more memories, the one or more processors configured to cause the device to perform the method of one or more of Aspects 1-52.

Aspect 55: An apparatus for wireless communication, the apparatus comprising at least one means for performing the method of one or more of Aspects 1-52.

Aspect 56: A non-transitory computer-readable medium storing code for wireless communication, the code comprising instructions executable by one or more processors to perform the method of one or more of Aspects 1-52.

Aspect 57: A non-transitory computer-readable medium storing a set of instructions for wireless communication, the set of instructions comprising one or more instructions that, when executed by one or more processors of a device, cause the device to perform the method of one or more of Aspects 1-52.

Aspect 58: A device for wireless communication, the device comprising a processing system that includes one or more processors and one or more memories coupled with the one or more processors, the processing system configured to cause the device to perform the method of one or more of Aspects 1-52.

Aspect 59: An apparatus for wireless communication at a device, the apparatus comprising one or more memories and one or more processors coupled to the one or more memories, the one or more processors individually or collectively configured to cause the device to perform the method of one or more of Aspects 1-52.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories coupled with the one or more processors, the processing system configured to cause the UE to:
receive, from a network node, configuration information that indicates a plurality of parameters associated with an upper bound for selection of a permissible power parameter, wherein the permissible power parameter is associated with an output power for wireless transmissions to the network node; and
transmit, to the network node, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE.

2. The UE of claim 1, wherein the plurality of parameters includes a permissible power level associated with a cell, and wherein the upper bound is in accordance with the permissible power level.

3. The UE of claim 2, wherein:
the plurality of parameters include a set of permissible power levels respectively associated with a set of cells, and
the permissible power level is a lowest permissible power level from the set of permissible power levels respectively associated with the set of cells or is a highest permissible power level from the set of permissible power levels respectively associated with the set of cells.

4. The UE of claim 1, wherein the processing system is further configured to cause the UE to:
receive, from the network node, signaling that indicates the range of power class values.

5. The UE of claim 1, wherein the range of power class values is associated with a lower bound and is not associated with an upper bound.

6. The UE of claim 1, wherein the range of power class values is associated with a lower bound and is associated with an upper bound.

7. The UE of claim 1, wherein the range of power class values is in accordance with one or more of a device type associated with the UE, a frequency band associated with the wireless transmissions to the network node, or a frequency range associated with the wireless transmissions to the network node.

8. The UE of claim 1, wherein the UE is associated with one or more maximum power reduction (MPR) tables, and wherein the processing system is further configured to cause the UE to:
transmit, to the network node, a report that indicates an association between a power class value from the range of power class values and an MPR table from the one or more MPR tables.

9. The UE of claim 1, wherein the range of power class values is partitioned into multiple range segments that respectively span portions of the range of power class values, and wherein the multiple range segments are respectively associated with multiple maximum power reduction (MPR) tables.

10. The UE of claim 9, wherein the processing system is further configured to cause the UE to:
receive, from the network node, signaling that indicates the multiple range segments and indicates respective associations between the multiple range segments and the multiple MPR tables.

11. The UE of claim 9, wherein the multiple range segments and respective associations between the multiple range segments and the multiple MPR tables are in accordance with one or more of a preference of the UE or a capability of the UE.

12. The UE of claim 1, wherein the processing system is further configured to cause the UE to:
receive, from the network node, control information that allocates an uplink grant associated with a first modulation and coding scheme (MCS); and
transmit, to the network node, a report that indicates one or more of a first maximum power reduction (MPR) value associated with the first MCS of the uplink grant, one or more second MPR values respectively associated with one or more second MCSs lower than the first MCS, or one or more third MPR values respectively associated with one or more third MCSs lower than the first MCS.

13. The UE of claim 12, wherein the processing system is further configured to cause the UE to:
receive, from the network node, signaling that indicates multiple ranges of MPR values respectively associated with multiple MCSs, wherein one or more of the first MPR value, the one or more second MPR values, or the one or more third MPR values are in accordance with the multiple ranges of MPR values respectively associated with the multiple MCSs.

14. The UE of claim 1, wherein the processing system is further configured to cause the UE to:
transmit, to the network node, a report that indicates a power class value from the range of power class values and a maximum power reduction (MPR) value associated with a set of waveforms, wherein the MPR value is indicated in accordance with a combination of the power class value and the MPR value satisfying the permissible power parameter for a threshold percentage of waveforms of the set of waveforms.

15. The UE of claim 14, wherein the processing system is further configured to cause the UE to:
receive, from the network node, signaling that indicates the threshold percentage of waveforms.

16. The UE of claim 14, wherein the processing system is further configured to cause the UE to:
receive, from the network node, signaling that indicates a range of threshold percentages of waveforms that includes the threshold percentage of waveforms, wherein the report indicates the threshold percentages of waveforms.

17. The UE of claim 1, wherein the processing system is further configured to cause the UE to:
transmit, to the network node, a report that indicates a power class value from the range of power class values in accordance with the power class value supporting a duty cycle associated with a duty cycle percentage that satisfies a threshold.

18. The UE of claim 17, wherein one or more power class values of the range of power class values are respectively associated with one or more thresholds associated with duty cycle percentage.

19. A network node for wireless communication, comprising:
a processing system that includes one or more processors and one or more memories coupled with the one or more processors, the processing system configured to cause the network node to:
transmit, to a user equipment (UE), configuration information that indicates a plurality of parameters associated with an upper bound for selection of a permissible power parameter, wherein the permissible power parameter is associated with an output power for wireless transmissions to the network node; and
receive, from the UE, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the UE.

20. An apparatus for wireless communication, comprising:
means for receiving, from a network node, configuration information that indicates a plurality of parameters associated with an upper bound for selection of a permissible power parameter, wherein the permissible power parameter is associated with an output power for wireless transmissions to the network node; and
means for transmitting, to the network node, a message at an output power level, wherein the output power level is in accordance with the permissible power parameter selected in accordance with the upper bound and in accordance with a flexible power class value selected from a range of power class values, wherein the range of power class values indicates a range for a permissible output power capability of the apparatus.
